(19) United States
(12) Patent Application Publication
(10) Pub. No.: US 2004/0128193 A1
(43) Pub. Date: Jul. 1, 2004

(54) Methods and systems for providing an integrated merchandising and shopping environment

(75) Inventors: Tony Brice, Colleyville, TX (US); Russell Flynn, Sandford, FL (US); Aaron Frydman, Dallas, TX (US); Corinne Goyette, Euless, TX (US); Rebecca Robinson, Irving, TX (US); Elizabeth McNeil, Allen, TX (US); Virginia Mahl, Flower Mound, TX (US); Rod Miller, Flower Mound, TX (US); Rajesh Natarajan, Keller, TX (US); Robert Offutt, Grapevine, TX (US); Richard Pendergast, North Richland Hills, TX (US); Amer Waheed, Flower Mound, TX (US); Cara Whitehill, Dallas, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX

(21) Appl. No.: 10/635,292

(22) Filed: Aug. 6, 2003

Related U.S. Application Data
(60) Provisional application No. 60/401,025, filed on Aug. 6, 2002.

(51) Int. Cl. G06F 17/60

(52) U.S. Cl. 705/14

(57) ABSTRACT

A system and method are provided that receive a purchase request from a user that includes purchase profile information. The request is collected along with information provided from one or more suppliers and seller merchandising rules to generate one or more purchase options that matches some of the purchase profile information and marketing objectives of the seller and/or its business partner(s). Further, the system and method may monitor selling and buying activities associated with a type of purchase option provided by the seller. Based on the monitoring, merchandising rules are adjusted that affect how purchase offers are generated and provided to a requesting user. Accordingly, new purchase offers are generated based on the adjustments and facilitate, for example, the seller or its partners meeting its marketing objectives.

### RELATED APPLICATIONS

The present application claims priority from U.S. Provisional Application No. 60/401,025 filed Aug. 6, 2002; the contents of which are incorporated by reference herein.

### BACKGROUND OF THE INVENTION

I. Field of the Invention

This invention relates to marketing systems and, more particularly, to systems and methods for assembling purchase options based on information associated with multiple sources.

II. Background and Material Information

Recently, on-line shopping platforms have been introduced on the Internet to provide customers with an accessible environment to browse and purchase goods and/or services. These platforms are associated with many different industries (e.g., travel, manufacturing, retail, etc.) and are tailored as such. For example, travel-based on-line shopping platforms, such as Oribitz.com and Expedia.com, allow a user to have access to airline flight schedules, seat availability, and itinerary prices through a computer system executing a browser program. A user may request, through the browser, travel information associated with a planned trip and the on-line shopping platform returns various travel options based on the request. The user may then select and purchase available travel options.

Although the aforementioned shopping platforms allow a user to tailor a travel-based request to their personal needs or expectations, these platforms do not take into account the business plans associated with the respective platform. Accordingly, there is a need for a method and system to provide purchase offers that meet the needs of a potential buyer and simultaneously represent the merchandising goals of the seller, its supplier partners, and its reseller partners.

### SUMMARY OF THE INVENTION

A method and an associated offer generating module have therefore been developed to provide purchase offers that take into account not only the purchase profile information provided by a user, i.e., a potential customer, but also marketing criteria of a supplier and/or a seller. As such, the method and offer generating module of the present invention permit a seller to balance the sometimes competing demands of the user and various suppliers.

According to one aspect of the present invention, the offer generating module receives a purchase request including purchase profile information from a user. The offer generating module then determines a set of purchase options based upon the purchase profile information. In one embodiment, the set of purchase options is determined by initially selecting from among the plurality of databases containing the various purchase options and thereafter searching the selected database(s) to identify the set of purchase options. As such, the particular database to be searched can be selected based upon the user and/or the purchase profile information.

The offer generating module then determines a point value for each purchase option based on characteristics associated with the respective purchase option. In this regard, a point value may be determined for each purchase option, and penalty points may then be assessed for at least some purchase options based upon variations between the purchase profile information and the respective purchase option and/or the availability of the respective purchase options. In one embodiment in which a user is attempting to purchase a flight, the point value for each flight option is determined by determining an initial point value for the flight option and thereafter assessing penalty points based on the departure time, the connection service, and the inventory class status.

The offer generating module then provides one or more purchase offers associated with respective purchase options based upon the point value for the purchase options and further based upon marketing criteria of the supplier that provides the flight options and/or a seller that provides one or more of the purchase offers. The marketing criteria therefore provides merchandising rules that may partially dictate the purchase offers that are provided to the user. In this regard, the purchase offers from a respective supplier may be limited, such as to a predetermined number and/or the manner in which the purchase offers are presented to the user may be dictated by the marketing criteria. For example, the purchase offers provided by respective suppliers may be presented in a location relative to the purchase offers provided by other suppliers that is based upon the marketing criteria of the supplier and the seller. Likewise, the purchase offers provided by a respective supplier may be presented in a format relative to the purchase offers provided by the other supplier that is based upon the marketing criteria of the supplier and the seller. The manner in which the purchase offers are provided to the user maybe altered to achieve the marketing criteria based upon the past purchase transactions, which may also be monitored in accordance with one aspect of the present invention.

The marketing criteria of the supplier and the seller may also dictate the number of purchase options provided by each supplier that are available to the user. In this regard, the offer generating module can construct a plurality of data structures with each data structure including no more than a predefined number of purchase options for a respective supplier. As such, the purchase offers that are provided to the user are selected from among the purchase options contained within the plurality of data structures. In order to emphasize or de-emphasize the products offered by a respective supplier, the data structure associated with the particular supplier may be increased or decreased in size, respectively.

As such, the method and offer generating module of the present invention permit a plurality of purchase offers that at least partially comply with the purchase profile information of a purchase request to be provided. Moreover, the method and offer generating module permit the various purchase offers to be identified while taking into account the marketing criteria of one or more suppliers and the seller. As such, the method and offer generating module attempt to satisfy the sometimes competing demands of the users and the various suppliers that must be balanced by the seller.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain features and principles related to the present invention may be implemented;

FIG. 2 shows a flowchart of an exemplary offer generating process consistent with certain aspects related to the present invention; and

FIG. 3 shows a flowchart of an exemplary analysis process consistent with certain aspects related to the present invention.

### DETAILED DESCRIPTION

Generally, the present invention is directed to methods and systems for providing purchasing options to a user that meet requested service needs of the user and marketing objectives of a seller marketing the options. In one aspect of the invention, a system is provided that performs a process that accesses information such as airline schedules, airline seat availability, airline ticket prices, low fare search engines, seller merchandising rules, and shopper profile information. This information is gathered and used to formulate offers that simultaneously represent the merchandising goals of the seller and its business partners and are attractive to potential buyers (i.e., include one or more options that are likely to meet the needs of the potential buyers). Additionally, the process may formulate offers associated with other products or services such as non-air travel related products and services like lodging, rental cars, tours, cruises, ferries, rail travel, limousine services, bus services, scheduled events, and other options typically associated with travel. Further, the process may formulate offers associated with non-travel product marketing where access to multiple, independent components is required to formulate offers and meet marketing objectives associated with a seller. The process allows a seller to manage its own preference rules, product scoring logic, and pricing methodologies for the purpose of exposing and selling products to meet marketing objectives. Moreover, the process enables the seller to provide access to suppliers and/or resellers who wish to manage their own business rules that are applicable to the creation and provision of the offers.

Additionally, methods and systems consistent with certain aspects of the present invention perform automatic analysis of buying and selling activities. The results of the analysis may be compared to quantifiable marketing objectives and used to automatically adjust the seller and/or supplier rules, scoring logic, and/or pricing methodologies. For example, the auto-adjustments may be performed to meet a number of different marketing objectives, including, but not limited to, adjusting a supplier's market share for specific supplier products and/or services, maximizing revenue/yield for the seller, its resellers, and its supplier partners, and creating more attractive offers for potential buyers.

Reference will now be made in detail to the invention, examples of which are illustrated in the accompanying drawings. Wherever possible, the same reference numbers will be used throughout the drawings to refer to the same or like parts.

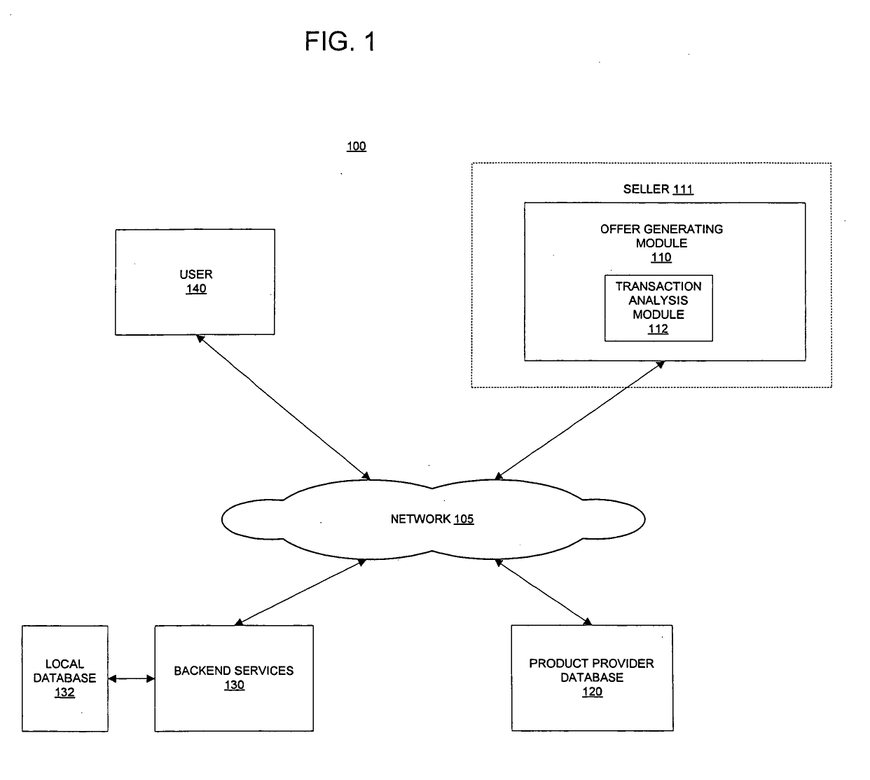

FIG. 1 illustrates an exemplary computing system environment 100 consistent with certain aspects related to the present invention. As shown, system 100 may include a network 105, offer generating module 110 (also known as a rules engine), seller 111, transaction analysis module 112, product provider database 120, backend services 130, database 132, and a user 140. Network 105 may represent any type of communication network that facilitates the exchange of information between remote entities, such as the elements shown in FIG. 1. Network 105 may be any type of network known in the art. For example network 105 may include a Local Area Network, Wide Area Network, combinations of switching networks, and the Internet. Furthermore, network 105 may process wireline and wireless communications to and from any entity attached thereto.

Offer generating module 110, may be associated with seller 111, which may represent a business entity that markets and/or advertises products provided by the seller or other entities. The term “product” as used herein may represent a product or service that may be offered, sold and/or used by one or more buyers. For example, a product may represent travel services, such as airline flights, lodging services, rental vehicles, travel tours, cruises, ferries, rail travel services, limousine services, bus services, scheduled events, and other types of services associated with travel. Alternatively, a product may represent non-travel services, such as a manufactured item. A “buyer” as the term is used herein may represent an individual, group of individuals, a business organization, or a group of business organizations, that may purchase, or attempt to purchase, a product. Offer generating module 110 may be a processing element such as a computing system that includes one or more processing components that enable the module to perform functions consistent with certain aspects related to the present invention (not shown). For example, module 110 may include one or more processors that execute program code stored in one or more memory devices. Further, offer generating module 110 may include interface devices that allow components of module 110 to exchange information between each other and with remote components and/or systems directly or indirectly, such as through network 105. Alternatively, offer generating module 110 may be program code stored in one or more memory devices that performs, when executed by a processor device, one or more processes consistent with certain features related to the present invention. In one aspect of the invention, offer generating module 110 may generate and provide purchase offers to a buyer (e.g., user 140) for one or more products provided by one or more providers, such as an airline company.

Offer generating module 110 may include transaction analysis module 112 that may be a separate computing system including separate computing components, such as a processor, memory devices, and interface devices. Alternatively, transaction analysis module 112 may represent program code that, when executed by a processor, performs one or more processes consistent with certain features related to the present invention. In one aspect of the invention, transaction analysis module 112 may analyze buying and selling activities between user 140, seller 111, and one or more providers of products that may be purchased by user 140.

Product provider database 120 represents one or more databases that may include information associated with one or more products provided by a business entity, such as a travel-based provider (e.g., an airline, travel agency, car rental business, etc.) and non-travel based provider (e.g., manufacturer, retailer, etc.). In one aspect of the present invention, provider database 120 may include information on airline flight schedules, airline seat availability, airline ticket prices, etc., associated with an airline. An airline represents one example of a “carrier,” and an airline database 120 may include airline flight schedules, airline seat availability, airline ticket prices, etc., associated with an airline. Other carriers like train or bus companies may use similar departure-arrival schedules, seat availability, ticket prices, etc. as appropriate for the specific mode of transportation and industry.

Further, although FIG. 1 shows one product provider database 120, a plurality of databases, each associated with a respective different airline, may be implemented without departing from the scope of the present invention.

Backend services 130 may represent a computing system that collects the product information maintained in product provider database 120 and provides the product information to requesting entities, such as offer generating module 110. In one aspect of the invention, backend services 130 may request and collect product information from product database 120 periodically or on an as-needed basis. Backend services 130 may also include a database 132 that maintains product information collected from product database 120. In one aspect of the invention, database 132 may store product information that is periodically collected from product database 120 by backend services 130. Accordingly, backend services 130 may provide the product information stored in database 132 to offer generating module 110 in place of, or in addition to, product information collected from product database 120.

User 140 represents a user that may operate a computing system that includes a browser application executed by a processor and a display device that presents information to the user. In one aspect of the invention, user 140 may request and receive, via the browser application (or other interface software for facilitating communication with an application running on a remote machine), one or more purchase offers provided by offer generating module 110. The purchase offers may be processed by the browser and presented in the display device included in the computing system operated by the user.

One skilled in the art would appreciate that the configuration of computing system is exemplary and not limited to that shown in FIG. 1. For example, although network 105 may be used by the components of system 100 to exchange information, these components may include communication paths that enable direct communication between selected components. For example, offer generating module 110 may be directly connected to backend services 130.

As shown, computing system 100 is configured to enable offer generating module 110 to create and provide multiple purchase offers to user 140 based on information provided by one or more sources. In one aspect of the invention, offer generating module 110 performs an offer generating process that assigns point values to selected flights associated with one or more carriers. From these initial point values, penalty points are added based on various characteristics associated with each respective flight. Those flights with the remaining best point values (e.g., lowest point values) may be selected as offers for user 140.

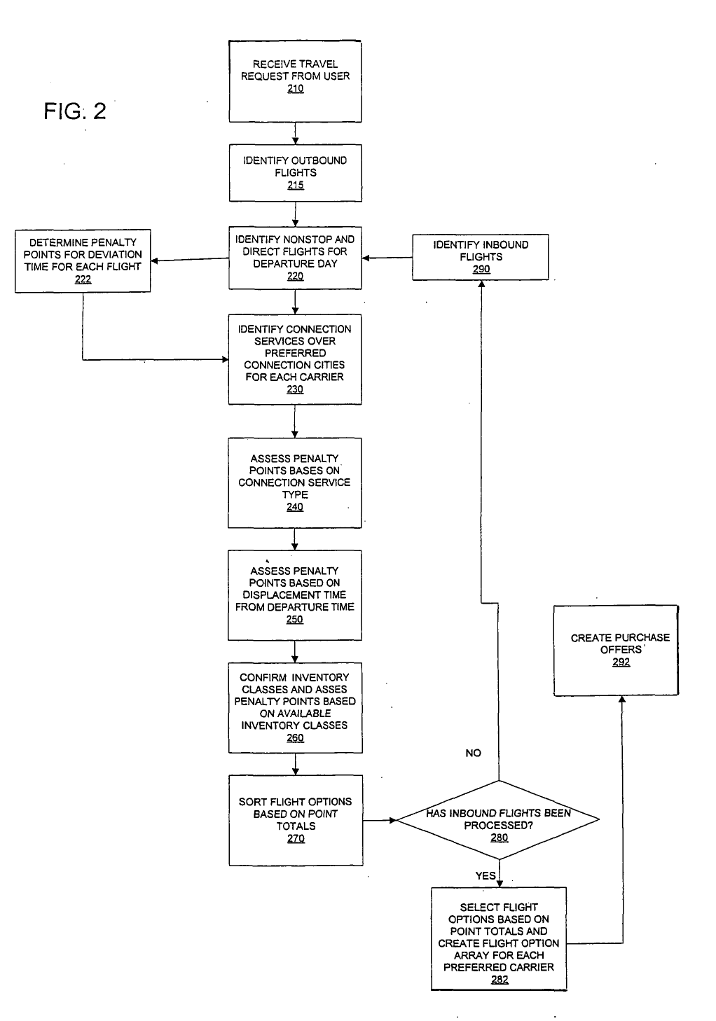

FIG. 2 shows a flowchart of an exemplary offer generating process consistent with certain features related to the present invention. Although the offer generating process shown in FIG. 2 is described with respect to airline services provided by one or more carriers (e.g., airline companies), one skilled in the art would appreciate that the offer generating process may be applicable to other types of products without departing from the scope of the present invention.

The offer generating process may begin when user 140 sends a request to seller 111. User 140 may send the request to seller 111 through network 105, or alternatively, user 140 may send the request directly to seller 111 through a communication path connected between user 140 and seller 111. In one aspect of the invention, user 140 may generate the request based on information included on a web page provided by a web server (not shown) that may be maintained by seller 111. The web page may include different types of content based on the types of products (e.g., travel services) marketed by seller 111. The web page may also provide options for user 140 to select an origination location, a destination location, travel dates, and other forms of user-based travel based profile information. For example, the user may select an acceptable range of time associated with a departure or arrival time for a flight, such as plus or minus two hours.

The request is received by seller 111 and provided to offer generating module 110 where outbound flights are identified (e.g., flights departing from the destination location included in the request) (step 215). Module 110 may then identify all nonstop and direct flights that are available from one or more carriers on the day of departure identified in the request provided by user 140 (step 220). In one aspect of the invention, offer generating module 110 may obtain travel information from one or more of multiple sources to determine the types of flight options available from one or more carriers. For example, module 110 may collect flight schedule information, flight seat availability information, and ticket price information from backend services 130, or directly from provider database 120. The offer generating module 110 may determine which source(s) to query based upon various factors including, for example, the type of user and the purchase profile information. For example, the offer generating module 110 may access different sources if an individual requests information as opposed to a request from a travel agency. Backend services 130 may receive the request for travel between the origination and destination locations, and retrieve the appropriate travel information from local database 132 and/or each respective provider database 120 associated with a corresponding carrier. The retrieved information may then be provided back to module 110 for processing. Additionally, module 110 may receive pricing information from a low fare search engine that searches for the lowest airline fares for flights that meet the travel profile specified in the request provided by user 140. Also, as described below, offer generating module may receive information from internal components, such as merchandising rules and profile information from seller 111. Also user profile information associated with user 140 may be collected by module 140 either locally or remotely to determine the types of offers to provide to user 140.

In one aspect of the invention, module 110 may calculate a total journey time for each flight options determined from step 220 to generate one or more purchase offers. The calculated journey time for each flight may be configured into a data value that represents a point total travel value for the respective flight. The total point travel value represents a baseline value that, in one aspect of the invention, is used as an initial data value from which penalty points are added. One type of penalty point assessment is based on the service type and a deviation time from the destination time included in the request (step 222). Table 1 shows an exemplary point assessment based on exemplary time deviations from the destination time in the request.

TABLE 1
Exemplary Penalty Point Table for Departure Time Deviations

Departure time

| | +/− 6 hrs of | > +/− 6 hrs of |
|---|---|---|
| Service Type | desired time | desired time |
| Non stop | 0 | 50 |
| Direct | 50 | 100 |

Offer generating module 110 may also assess penalty points based on flight services associated with connecting flights and connecting cities. Accordingly, offer generating module 110 may identify connecting service from a set of predetermined connection cities (step 230). In one aspect of the invention, each airline may be associated with a number of predetermined connection cities. Table 2 shows a list of exemplary connection cities associated with a set of exemplary airline based carriers.

TABLE 2
Exemplary Connection Cities

| Carrier | City | City | | | | | |
|---|---|---|---|---|---|---|---|
| Code | 1 | 2 | City 3 | City 4 | City 5 | City 6 | City 7 |
| Airline 1 | DFW | ORD | MIA | STL | LAX | | |
| Airline 2 | ATL | CVG | SLC | DFW | | | |
| Airline 3 | IAH | EWR | CLE | MSP | DTW | MEM | PHX |
| Airline 4 | MSP | DTW | MEM | IAH | EWR | CLE | |
| Airline 5 | PIT | CLT | PHL | | | | |
| Airline 6 | PHX | LAS | IAH | CMH | EWR | CLE | ORD |
| Airline 7 | DEN | ORD | lAD | SFO | | | |

When determining penalty points for connecting flight options, the total travel time, including time on ground, for each connection flight option is determined by offer generating module 110. This total travel time may be different from the travel time determined in step 222, or it may be the same. The total travel time is configured into a point total for each connection flight. From the connection point total, penalty points may be added based on connection service type and the displacement time associated with the connecting flight. Tables 3 and 4 show a listing of exemplary penalty points for connection service and displacement time, respectively.

TABLE 3
Connection Service Type Penalty points

| Connection Service | Penalty |
|---|---|
| Type | Points |
| Nonstop-Nonstop | 70 |
| Nonstop-Direct | 120 |
| Direct-Nonstop | 120 |
| Direct-Direct | 150 |

TABLE 4
Displacement Penalty Points

| Displacement | Penalty |
|---|---|
| (minutes) | Points |
| 0-59 | 0 |
| 60-119 | 10 |
| 120-179 | 20 |
| 180-239 | 30 |
| 240-299 | 40 |
| 300-359 | 50 |
| 360-419 | 60 |
| 420-479 | 70 |
| 480-539 | 80 |
| 540-599 | 90 |
| 600-659 | 100 |
| 660-719 | 110 |
| 720+ | 120 |

Offer generating module 110 may implement one or more conditions to filter flight options automatically, thus reducing processing time. For example, connecting flight options that have travel times from departure to arrival that is longer than 299% of the nonstop travel time between the destination and origination locations may be removed from consideration by module 110. Further, connection times on the ground that are longer than 4 hours may also be eliminated from being used in generating a purchase offer. Also, a condition that the connections be from the same carrier may be implemented by module 110 to filter flight options from consideration as a purchase offer. One skilled in the art would appreciate that many types of conditions, if any at all, may be implemented without departing from the scope of the present invention.

Another type of penalty points that may be assessed by offer generating module 110 may be based on availability as reflected by the inventory class status for each carrier that offers the one or more flights options in the foregoing example regarding a search for airfares. Table 5 shows a list of exemplary inventory classes for the set of exemplary carriers.

TABLE 5
Inventory Classes

| Carrier | Class | Class | Class | Class | Class | Class | Class | Class |
|---|---|---|---|---|---|---|---|---|
| Code | 1 | 2 | 3 | 4 | 5 | 6 | 7 | 8 |
| Airline 1 | M | Q | K | V | N | L | H | B |
| Airline 2 | M | H | Q | K | L | U | B | |
| Airline 3 | H | K | B | V | Q | T | | |
| Airline 4 | B | M | H | Q | V | K | Y | |
| Airline 5 | B | M | H | K | V | | | |
| Airline 6 | B | Q | L | K | V | M | W | H |
| Airline 7 | M | H | Q | V | W | T | B | |

An inventory class may refer to a type of booking class for certain types of seats on a flight. For example, class 1 for Airline 1 includes a booking class of “M”, which represents one type of fare grouping for a flight. The booking classes in inventory class 1 may represent the more economical (i.e., cheaper) fares for a flight, while the booking classes in inventory class 8 may represent the most expensive fares. Thus, for Airline 1 a flight may consist of 8 inventory classes that may represent various priced fares ranging from booking class M to booking class B.

Based on whether a type of inventory class is closed (e.g., no seats available for the booking class associated with the airline's respective inventory class) on one or both legs of a connection, module 110 may assess corresponding penalty points to the point total for a respective flight option. Table 6 shows a listing of exemplary penalty points based on a number of Inventory classes that are closed.

TABLE 6
Penalty Points for Closed Inventory Classes

| # Inventory classes | Points |
|---|---|
| ‘closed’ | Assigned |
| 0 | 0 |
| 1 | 10 |
| 2 | 20 |
| 3 | 30 |
| 4 | 40 |
| 5+ | 50 |

Once offer generating module 110 assesses the penalty points for each flight options, the options are sorted based on each option's remaining total point value (step 270). In one embodiment, module 110 sorts the flight options from lowest to highest point totals reflecting the most favorable flight options for the seller or its business partners and user 140. Module 110 also determines whether inbound flight options have been processed (step 280). If not (step 280; NO), module 110 identifies the inbound flight options offered by the preferred airlines (step 290) and the offer generating process is repeated from step 220. As will be apparent, the inbound and outbound flight options may be processed in the other order or simultaneously, if desired.

On the other hand, if the inbound flight options have been processed (step 280; YES), offer generating module 110 selects a set of inbound and outbound flights options for offer generation (step 282). In one aspect of the invention, module 110 may select a set of inbound and outbound flight options for each preferred carrier that have the lowest point totals among the remaining point totals from the processed flight options. For example, offer generating module 110 may select the lowest 10% of flight options based on the options' point totals. Alternatively, module 110 may select a predetermined number of flight options from the sorted inbound and outbound flight options. The selected number would include those options with the lowest point totals.

Once the inbound and outbound flight options are selected, offer generating module 110 may create one or more data structures (e.g., matrix arrays) reflecting the flight options for each preferred carrier (step 282). In one aspect of the invention, a matrix of information of different sizes may be created for various origination and destination location pairs based on the airline's offering travel between the locations. For example, module 110 may create a 12×12 matrix of inbound/outbound flight information for an airline that offers twelve flights a day between an origination and destination location. In one aspect of the invention, module 110 may determine the size of each matrix based on one or more merchandising rules that affect the scoring logic for each carrier and/or flight option. For example, the origination and destination locations included in each flight option and the type of airline may affect the size of the matrices generated. Thus, if an airline offers twelve flights a day between a destination location and origination location, module 110 may reduce the matrix size for this airline based on a merchandising rule associated with the airline (e.g., increase market share for flights out of Dallas Fort Worth, etc.) Accordingly, a business entity, such as an airline, may have a partnership with seller 111 that causes offer generating module 110 to create larger sized matrices for the partner, thus allowing more flight options to be included therein. Further, different pairs of origination and destination locations may affect the size of each matrix for each airline. Table 7 shows a listing of exemplary matrix sizes for corresponding airlines and a set of exemplary origination and destination locations. If an airline has more flights between a pair of origination and destination locations than may be included in the respective matrix, the flights with the lowest point totals are generally included in the matrix.

TABLE 7
Matrix Management Table

| O&D | | Matrix # (Size) | | | | | |
|---|---|---|---|---|---|---|---|
| Origin | Destination | 1 (7 × 7) | 2 (5 × 5) | 3 (5 × 5) | 4 (3 × 3) | 5 (3 × 3) | 6 (3 × 3) |
| DFW | BOS | Airline 1 | Airline 2 | Airline 3 | Airline 4 | Airline 5 | Airline 6 |
| MSP | LAX | Airline 3 | Airline 4 | Airline 1 | Airline 2 | Airline 5 | |
| NYC | LAX | Airline 1 | Airline 3 | Airline 2 | | | |

Additionally, certain aspects of the invention enable different sized matrices to be created based on the travel request received by user 140. For example, if user 140 specifies in a request that they must leave by 10:00 AM on a Friday, but can return anytime on Sunday, a matrix of various sizes may be created, such as a 3×8 matrix representing three possible outbound flight options and eight possible inbound flight options for a total of 24 flight options.

Based on the number of matrices determined for each airline and origination and destination city pair, offer generating module 110 may generate purchase offers for presentation to user 140 (step 292). Module 110 may select a determined number (e.g., one, two, all, etc.) of flight options from the matrices developed in step 282. Offer generating module 110 uses the generated offers as content for a document (e.g., web page) that provides results to the request received from user 140. For example, the document may include a listing of inbound or outbound flight options that were included in the matrices generated by module 110. Further, the number, type, and position on the document of purchase offers may be determined based on merchandising rules, associated with seller 111 and/or its partners. For example, Table 8 shows an exemplary listing of content display rules associated with the preferred airlines. Module 110 may use the information in Table 8 to determine the rank of each airline. As shown, the rank of an airline may be specific to a partuclar pair of origination and destination locations or may be more generally defined as indicated by “default”. In turn, an airline's rank determines how much weight, or preference, to give to an airline based on the origination and destination locations. Accordingly, a selling partner (e.g., airline) that has a partnership with seller 111 may be given more weight by module 110 when determining the location and number of flight options to include in the document from that airline. Having more weight may enable an airline's flight options to be placed in high profile locations on the document provided to user 140.

TABLE 8
Display Management Table

| CSC | | | | | |
|---|---|---|---|---|---|
| Country | Origin | Destination | Carrier | Rank | |
| Code (Key) | (Key) | (Key) | Code (Key) | Level | Weight |
| US | ORD | DFW | Airline 1 | 1 | 100% |
| US | ORD | DFW | Airline 2 | 2 | 100% |
| US | ORD | DFW | Airline 3 | 3 | 50% |
| US | ORD | DFW | Airline 4 | 3 | 50% |
| US | ORD | DFW | Airline 5 | 4 | 100% |
| US | ORD | DFW | Airline 6 | 5 | 75% |
| US | ORD | DFW | Airline 7 | 5 | 25% |
| US | ORD | DFW | Others | NP | 100% |
| US | DEFAULT | DEFAULT | Airline 1 | 1 | 100% |
| US | DEFAULT | DEFAULT | Airline 2 | 2 | 50% |
| US | DEFAULT | DEFAULT | Airline 3 | 2 | 50% |

In addition to ranking the airlines, the display management table of Table 8 also weights the airlines if two or more airlines are assigned the same rank. The weights identify the percentage of documents in which the respective airline will be considered to have the particular rank. With reference to Airlines 6 and 7 who both are ranked fifth for flights from ORD to DFW, Airline 6 would be considered to be ranked fifth for the listings generated for 75% of the resulting documents, and Airline 7 would be considered to be ranked fifth for the listings generated for the other 25% of the resulting documents. In instances in which Airlines 6 and 7 are not considered to be ranked fifth, the airline is effectively ranked sixth. As also shown in Table 8, airlines other than Airlines 1-7 who fly between ORD and DFW have a “non-partners” (NP) rank which follows the rank of 5 in this example.

Further, module 110 may access a display management table to determine the minimum and maximum size of each displayed response for each purchase offer to user 140. The size corresponding to the number of flight options from each airline that may be included in a document provided to user 140. Table 9 shows a listing of an exemplary relationship between airline rank levels and the number of flight options to include in the document that is provided to user 140.

TABLE 9
Display Management Table for Displayed Response Size

| | | | | Max # of | |
|---|---|---|---|---|---|
| | | | | outbound to | Max # of |
| | | | | display on | Outbounds to |
| CSC | | Airline Rank | | initial results | display on initial |
| Country | | Level after | Max | screen - Per | results screen - |
| Code | Request Type | Weighted | Fare | Fare Level for | Total for this |
| (Key) | (Key) | Sort (Key) | Levels | this airline | airline |
| US | Initial | 1 | 99 | 3 | 8 |
| US | Initial | 2 | 99 | 3 | 6 |
| US | Initial | 3 | 99 | 3 | 6 |
| US | Initial | 4 | 99 | 3 | 5 |
| US | Initial | 5 | 99 | 3 | 3 |
| US | Initial | 6 | 99 | 2 | 3 |
| US | Initial | 7 | 99 | 1 | 1 |
| US | Initial | 8 | 99 | 1 | 1 |
| US | Initial | 9 | 99 | 1 | 1 |
| US | Initial | Non-Partners | 1 | 1 | 1 |
| US | Carrier Specific | All | 99 | n/a - show all | n/a - show all |
| | Outbound** (1 | | | | |
| | airline only in | | | | |
| | original | | | | |
| | customer | | | | |
| | request) | | | | |
| US | Carrier Specific | Highest in | 99 | 99 | 99 |
| | Outbound (2 or | Partner List | | | |
| | 3 airlines in | (relative to | | | |
| | original | others | | | |
| | customer | included in the | | | |
| | request) | search | | | |
| US | Carrier Specific | Others in | 99 | 6 | 6 |
| | Outbound (2 or | Partner List | | | |
| | 3 airlines in | (not the | | | |
| | original | highest | | | |
| | customer | partner) | | | |
| | request) | | | | |
| US | Carrier Specific | Non Partners | 99 | 3 | 3 |
| | Outbound (2 or | | | | |
| | 3 airlines in | | | | |
| | original | | | | |
| | customer | | | | |
| | request) | | | | |
| US | Any | Any | If Over | If Over max, do | If Over Max, |
| | | | Max, do | not display | Display with No |
| | | | not | | Price “Select to |
| | | | display | | see price” |

Thus, for an initial request without any specification by the user of the particular carrier, the number of outbound flight legs for each fare level and in total that will be displayed on the initial results screen for an airline are based on the rank of the airline. In conjunction with the ranking of Table 8, Table 9 assists in maintaining carrier diversity in the displayed results. In instances in which the user requests a specific carrier, however, carrier diversity is no longer an objective and all of the displayed results will be provided by the requested carrier as shown in row 11 of Table 9. Additionally, rows 12-14 of Table 9 specify the flight legs to be displayed in which the user specifies two or three airlines in which a substantial portion of the displayed results is allocated to the highest ranking airline that has been specified. While shown as the final row, the final row merely identifies the manner in which the offer generating module 110 should respond if an airline has eligible flight legs that could be displayed, but for the numerical limits imposed by Table 9. While the foregoing description and Table 9 have related to the display of outbound flight legs, the method and offer generating module 110 of the present invention would also have a comparable table for use in conjunction with the display of inbound flight legs.

The merchandising rules applied by offer generating module 110 may be associated with certain goals for seller 111 or a selling partner, such as an airline based carrier. The rules may affect how the management data structures (e.g., matrices) are created and the information in each of the tables listed above are maintained. For example, seller 111 may assign priority to an airline for certain flight options based on an agreement between seller 11 and the airline and the airline's marketing goal. Accordingly, to give the airline a higher priority for purchasing offers, module 110 may adjust the weight value for the airline to ensure more flight options for that airline are included in responses to a user's request. Merchandising rules may include conditions that affect content location, frequency, display characteristics (i.e., format), etc. of itineraries, purchase offers, and other types of information marketed by seller 111. The conditions may be based on a business relationship between seller 111 and a partner, such as an airline. For instance, seller 111 may offer to selling partners, such as a service provider (e.g., airline), particular merchandising offers that will allow the partners to reach certain marketing goals, such as increasing revenue, market share, market exposure, etc. Based on the merchandising offers, seller 111 may configure offer generating module 110 to facilitate these goals. For example, module 110 may position a determined number of flight options for a particular airline based carrier in a location of the document that is historically known to have more exposure to users viewing the document (e.g., top of web page, top of a list of available flight options, larger text sizes, high profile graphics, etc.).

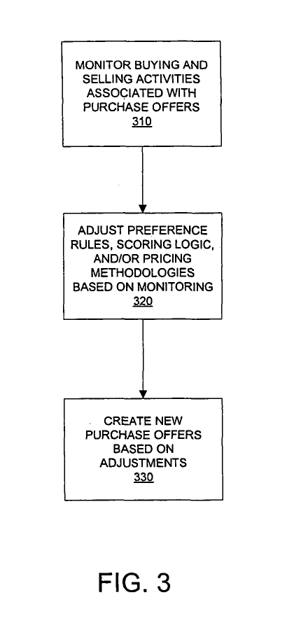

Accordingly, aspects of the present invention allow purchase offers to be generated that attempt to meet the needs of potential buyers (e.g., user 140) while at the same time meeting the merchandising goals of a seller and/or its partners. Additionally, aspects of the present invention enable the scoring logic, pricing methodologies, and preference rules reflected in the above exemplary tables to be dynamically adjusted based on monitored selling and buying activities. FIG. 3 shows an flowchart of an exemplary analysis process consistent with one aspect of the present invention.

As shown, transaction analysis module 112 may monitor the selling and buying activities associated with purchase offers presented in one or more documents that are provided to one or more users 140 (step 310). The activities monitored may include the types of flight options that were purchased by users, from what carriers, the number of flight options purchased, selected, and/or declined, and any other type of activity that is associated with the purchase, or attempted purchase, of the flight options presented by offer generating module 110.

The results of the monitored activities are compared to one or more marketing goals for seller 111 and/or a partner of seller 111, such as an airline. The marketing goals may be maintained as quantifiable data values, such as certain market share numbers for specific products, increasing revenue, increasing exposure (e.g., content renderings on one or more web pages) of certain products offered by a seller partner, etc. Based on the comparisons, transaction analysis module 112 may adjust the scoring logic used to assess penalties to the characteristics of selected flight options, the merchandising rules that affect the rendering characteristics of the flight options in a delivered document, and/or pricing methodologies, which include adjustments to prices for each flight option based on predetermined and negotiated deals with selected carriers (step 320). Once the merchandising rule(s) are adjusted, transaction analysis module 112 may allow offer generating module 110 to generate updated purchase offers in a manner similar to the process shown in FIG. 2 (step 330).

To illustrate the above described aspects of the invention, consider an exemplary airline A that has a market objective to increase its market share for a particular type of flight option by 2% in 6 months. Offer generating module 110 may generate offers for delivery to one or more users based on merchandising rules that take into account airline A's market objective. Therefore, for example, offer generating module 110 may implement a rule that increases the weight, or priority, of flight options offered by airline A in comparison with other airlines that offer similar flights. The offers are provided to requesting users (e.g., user 140) that request travel with a profile that is associated with the type of flight option airline A is marketing. For instance, the type of flight option may be a flight departing from a particular airport, such as Dallas Fort Worth. Accordingly, users that provide travel requests that identify Dallas Fort Worth as an origination location may be provided with content that includes one or more flight options offered by airline A in a document location that has a higher probability of being noticed by the requesting user, such as high profile locations on a web page, particular web pages, advertisements presented in various mediums, etc.

Transaction analysis module 112 may monitor buying and/or selling activities for the type of flight options marketed by airline A (e.g., departures from Dallas Fort Worth) over a period of time. Based on the results of the monitoring, transaction analysis module 112 may determine that the market objective for airline A is, or is not, on target, and makes adjustments to the merchandising rules accordingly. For example, after three months of monitoring, module 112 may determine that airline A's market share for flights from Dallas Fort Worth is on target for a 1% increase. Module 112 may then adjust one or more rules to increase the probability of the market objective to be obtained, such as increasing the frequency of flight option renderings on a web page, increasing the weight of airline A's flight options for display in a document, moving the location or display style of airline A's flight options to high profile locations and/or styles, respectively. Alternatively, if module 112 determines that airline A's market share is on target to exceed the 2% goal, the merchandising rules may be adjusted to reduce the probability of purchases for the target types of flight options, which has the effect of increasing the probability that users will select other flights. For example, flight options from airline A for the target flight option type may be moved to the bottom of a web page, or on a secondary web page.

According to one advantageous aspect of the present invention, the offer generating module 110 permits the above described method to vary dynamically. In this regard, the sources of the data from which the various purchase options are constructed may vary, such as based upon the user or the purchase profile information as described above. Additionally, one exemplary algorithm for scoring the various purchase options, such as by establishing a baseline point value and subsequently assessing penalty points based upon availability, variations from the purchase profile information or the like is described above. The offer generating module 110 can utilize several different algorithms with the particular algorithm that is utilized in response to a customer inquiry selected based upon the user, the purchase profile information or the like. For example, the system and method of the present invention may employ an algorithm that requires more extensive processing time and resources for users who are likely to purchase greater quantities of a product while utilizing an algorithm that is simpler in conjunction with inquiries by other users who are less likely to purchase extensive quantities of the product. Further, the merchandising criteria may also cause the offer generating module 110 to alter the manner in which purchase options are presented to the user based upon the purchase transactions detected by the transaction analysis module 112 since the relative preference for different suppliers may vary as product is sold and different thresholds that are contractually established between the suppliers and the sites are reached, as also described by way of example above. By permitting dynamic variations in the system and method of the present invention, the system and method of the present invention can be even more closely tailored to meet both the business objectives of the seller and the various suppliers, as well as the purchase profile information provided by the various users.

By way of example in the travel industry, the display parameters, such as those defined by the foregoing tables, are initially determined. The display parameters are typically defined based upon the marketing objectives of the seller and/or the various suppliers such that the results that will be subsequently presented to the user will likely include the desired mix of products. In response to a user inquiry, the candidate air schedules that comply with the user inquiry are established. Again, the marketing objectives are generally taken into account in determining the database(s) from which the candidate schedules are drawn to insure the air schedules include the desired mix of flights by the respective carriers. The availability of the various flights is determined from the schedule alternatives, and the available flights are then priced, typically either based upon the origination and destination or based upon the individual flight legs. Again, this pricing information can be provided by various data sources including local data sources or data sources maintained by the various suppliers. The available flights are then scored in accordance with the present invention. As described above, the results may then be merged with the results of a conventional low fare search to create the list of flights that best satisfy both the purchase profile information provided by the user and the merchandising rules established by the seller and/or the various suppliers.

As described, methods, systems, and articles of manufacture provide a system that generates and provides purchase offers that simultaneously meet the needs of potential buyers and the business requirements of a seller and/or its partners. Although the above description is associated with travel based applications, one skilled in the art would appreciate that the offer generating process and analysis process may be applied to other forms of products, such as non-travel based applications. Further, the sequence shown in FIGS. 2 and 3 are not intended to be limiting. That is, the offer generating process may perform any of the steps shown in FIG. 2 in various sequences without departing from the scope of the invention. Also, the configuration of FIG. 1 is not intended to be limiting. Different types of computing system configurations that incorporate different types of communication protocols, architectures, etc. may be implemented without departing from the scope of the invention.

For example, the method and system of the present invention may be employed in conjunction with the results of a low fare search for flights between the same origination and destination. In this embodiment, separate ranked listings of the flights are developed by a low fare search and by the points-based analysis as described above. The separate ranked listings are then merged based on various parameters designated by the system developer. For example, the separate ranked listings are typically merged based upon the fare, the time of day of the departure, the length of the trip, the carrier and the number of connections with each parameter weighted based upon its relative importance. As such, the system and method of this embodiment would not only identify flights that satisfy the purchaser profile information and the marketing criteria of the various suppliers and the seller, but also flights that are less expensive.

Additionally, the exemplary types of airlines, penalty points, and flight characteristics shown in the tables above are not intended to be limiting. Certain aspects of the present invention enable more or fewer airlines, and characteristics with associated penalty points to be implemented without departing from the scope of the invention. Also, the manner by which flight options are selected for inclusion in a purchase offer may vary. For example, instead of adding penalty points to flight options, offer generating module 110 may subtract points to more less favorable flight options and select the options with the higher total points for inclusion in the purchase offers provided to user 140. Additionally, users may provide input to determine the types of changes that need to be made to the merchandising rules based on the analysis results provided by transaction analysis module 112.

Furthermore, although aspects of the present invention are described as being associated with data stored in memory and other mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents.

What is claimed is:

1. A method for providing purchase offers, comprising:
receiving, from a user, a purchase request including purchase profile information;
determining a set of purchase options based on the purchase profile information;
determining a point value for each purchase option based on characteristics associated with the respective purchase option; and
providing one or more purchase offers associated with respective purchase options based upon the point values for the purchase options and further based upon a marketing criterion of at least one of a supplier that provides the purchase option and a seller that provides the one or more purchase offers.

2. The method of claim 1 wherein providing one or more purchase offers comprises limiting the purchase offers from a respective supplier based upon the marketing criteria of the supplier and the seller.

3. The method of claim 1 wherein providing one or more purchase offers comprises presenting the purchase offers to the user in accordance with the marketing criteria of the supplier and the seller.

4. The method of claim 1 further comprising:
monitoring purchase transactions associated with a type of purchase option offered by a supplier; and
adjusting the provision of purchase offers for the type of purchase option offered by the supplier based on the monitoring.

5. The method of claim 4, wherein adjusting the provision of purchase offers includes:
adjusting a number of times the type of purchase option offered by the supplier is included in a document that presents the purchase offers based on the monitoring.

6. The method of claim 4, wherein adjusting the provision of purchase offers includes:
adjusting a location of a purchase offer associated with the type of purchase option offered by a supplier in a document that presents the purchase offers based on the monitoring.

7. The method of claim 4, wherein adjusting the provision of purchase offers includes:
adjusting a format of a purchase offer associated with the type of purchase option offered by a supplier in a document that presents the purchase offers based on the monitoring.

8. The method of claim 1 wherein determining a point value for each purchase option includes:
determining an initial point value for each purchase option; and
assessing penalty points for at least some purchase options based upon at least one of variations between the purchase profile information and the respective purchase option and availability of the respective purchase option.

9. The method of claim 8 wherein the purchase option is a flight option, and wherein determining a point value for each purchase option includes:
determining a point value for the flight option,
assessing penalty points to the point value based on at least one of:
i) a departure displacement time for the flight option compared to a requested departure time included in the purchase request,
ii) a connection service type associated with the flight option, and
iii) an inventory class status associated with the flight option.

10. The method of claim 1 wherein the purchase request comprises a travel request including travel profile information, wherein the method further comprises:
identifying a plurality of candidate schedules based upon the travel request;
determining availability of the plurality of candidate schedules;
determining a price of at least those candidate schedules that are available, and
wherein the point value for each purchase option is determined for each of the candidate schedules that are available.

11. The method of claim 1 further comprising constructing a plurality of data structures with each data structure containing no more than a predefined number of purchase options for a respective supplier, and wherein providing one or more purchase offers comprises providing one or more purchase offers from among the purchase options contained within the plurality of data structures.

12. An offer generating module for providing purchase offers comprising:
a processing element adapted to receive, from a user, a purchase request including purchase profile information, said processing element also adapted to determine a set of purchase options based on the purchase profile information, said processing element further adapted to determine a point value for each purchase option based on characteristics associated with the respective purchase option, and said processing element additionally adapted to provide one or more purchase offers associated with respective purchase options based upon the point values for the purchase options and further based upon a marketing criterion of at least one of a supplier that provides the purchase option and a seller that provides the one or more purchase offers.

13. The offer generating module of claim 12 wherein said processing element is further capable of limiting the purchase offers from a respective supplier based upon the marketing criteria of the supplier and the seller.

14. The offer generating module of claim 12 wherein said processing element is further capable of presenting the purchase offers to the user in accordance with the marketing criteria of the supplier and the seller.

15. The offer generating module of claim 14 wherein said processing element is further capable of presenting the purchase offers provided by a respective supplier in a location relative to the purchase offers provided by other suppliers that is based upon the marketing criteria of the supplier and the seller.

16. The offer generating module of claim 14 wherein said processing element is further capable of presenting the purchase offers provided by a respective supplier in a format relative to the purchase offers provided by other suppliers that is based upon the marketing criteria of the supplier and the seller.

17. The offer generating module of claim 12 wherein said processing element is further capable of monitoring purchase transactions and adjusting the provision of purchase offers based upon the purchase transactions.

18. The offer generating module of claim 12 wherein said processor determines a point value for each purchase option by determining an initial point value for each purchase option, and by assessing penalty points for at least some purchase options based upon at least one of variations between the purchase profile information and the respective purchase option and availability of the respective purchase option.

19. The offer generating module of claim 12 wherein said processing element is further capable of constructing a plurality of data structures with each data structure containing no more than a predefined number of purchase options for a respective supplier, and wherein said processing element provides at least one purchase offer from among the purchase options contained within the plurality of data structures.

20. A method for providing purchase offers, comprising:
receiving, from a user, a purchase request including purchase profile information;
identifying a set of purchase options having respective scores based on their characteristics and the purchase request; and
providing at least one purchase offer based on the respective scores and associated marketing criteria;
wherein the manner in which the purchase options are identified, scored and provided is based upon at least one of the user, the purchase profile information and a supplier of the purchase offer.

21. The method of claim 20 wherein providing at least one purchase offer comprises limiting the purchase offers from a respective supplier based upon the marketing criteria of the supplier and the seller.

22. The method of claim 20 wherein providing at least one purchase offer comprises presenting the purchase offers to the user in accordance with the marketing criteria of the supplier and the seller.

23. The method of claim 22 wherein presenting the purchase offers comprises presenting the purchase offers provided by a respective supplier in a location relative to the purchase offers provided by other suppliers that is based upon the marketing criteria of the supplier and the seller.

24. The method of claim 22 wherein presenting the purchase offers comprises presenting the purchase offers provided by a respective supplier in a format relative to the purchase offers provided by other suppliers that is based upon the marketing criteria of the supplier and the seller.

25. The method of claim 20 further comprising monitoring purchase transactions and adjusting the provision of purchase offers based upon the purchase transactions.

26. The method of claim 20 wherein identifying the set of purchase options having respective scores comprises determining a point value for each purchase option; and assessing penalty points for at least some purchase options based upon at least one of variations between the purchase profile information and the respective purchase option and availability of the respective purchase option.

27. The method of claim 20 further comprising constructing a plurality of data structures with each data structure containing no more than a predefined number of purchase options for a respective supplier, and wherein providing at least one purchase offer comprises providing at least one purchase offer from among the purchase options contained within the plurality of data structures.

28. The method of claim 20 wherein identifying a set of purchase options comprises selecting at least one database of purchase options based upon at least one of the user and the purchase profile information, and subsequently searching the selected database to identify the set of purchase options.

29. The method of claim 20 wherein the purchase request comprises a travel request including travel profile information, wherein the method further comprises:
identifying a plurality of candidate schedules based upon the travel request;
determining availability of the plurality of candidate schedules;
determining a price of at least those candidate schedules that are available, and
wherein the scores for the set of purchase options are determined for each of the candidate schedules that are available.

30. An offer generating module for providing purchase offers comprising:
a processing element adapted to receive, from a user, a purchase request including purchase profile information, said processing element also adapted to identify a set of purchase options having respective scores based on their characteristics and the purchase request, and said processing element further adapted to provide at least one purchase offer based on the respective scores and associated marketing criteria, wherein the manner in which said processing element identifies and scores the purchase options and provides the purchase offer is based upon at least one of the user, the purchase profile information and a supplier of the purchase offer.

31. The offer generating module of claim 30 wherein said processing element is further capable of limiting the purchase offers from a respective supplier based upon the marketing criteria of the supplier and the seller.

32. The offer generating module of claim 30 wherein said processing element is further capable of presenting the purchase offers to the user in accordance with the marketing criteria of the supplier and the seller.

33. The offer generating module of claim 32 wherein said processing element is further capable of presenting the purchase offers provided by a respective supplier in a location relative to the purchase offers provided by other suppliers that is based upon the marketing criteria of the supplier and the seller.

34. The offer generating module of claim 32 wherein said processing element is further capable of presenting the purchase offers provided by a respective supplier in a format relative to the purchase offers provided by other suppliers that is based upon the marketing criteria of the supplier and the seller.

35. The offer generating module of claim 30 wherein said processing element is further capable of monitoring purchase transactions and adjusting the provision of purchase offers based upon the purchase transactions.

36. The offer generating module of claim 30 wherein said processing element is further capable of determining a point value for each purchase option; and assessing penalty points for at least some purchase options based upon at least one of variations between the purchase profile information and the respective purchase option and availability of the respective purchase option.

37. The offer generating module of claim 30 wherein said processing element is further capable of constructing a plurality of data structures with each data structure containing no more than a predefined number of purchase options for a respective supplier, and wherein said processing element provides at least one purchase offer from among the purchase options contained within the plurality of data structures.

38. The offer generating module of claim 30 wherein said processing element is capable of identifying the set of purchase options by selecting at least one database of purchase options based upon at least one of the user and the purchase profile information, and by subsequently searching the selected database to identify the set of purchase options.
